(19) United States
(12) Patent Application Publication
(10) Pub. No.: US 2024/0208863 A1
(43) Pub. Date: Jun. 27, 2024

(54) ENVIRONMENTALLY-FRIENDLY QUARTZ COMPOSITE BOARD AND MANUFACTURING METHOD THEREFOR

(71) Applicant: QUEEN CERAMIC INCORPORATION, TAIPEI CITY (TW)

(72) Inventor: CHENG-HSUAN LAI, TAIPEI CITY (TW)

(21) Appl. No.: 18/535,558

(22) Filed: Dec. 11, 2023

(30) Foreign Application Priority Data
Dec. 21, 2022 (TW) 111149273

(51) Int. Cl. C04B 14/06; C04B 18/167; C04B 24/42; C04B 26/18; C04B 40/00

(52) U.S. Cl. CPC C04B 14/06; C04B 18/167; C04B 24/42; C04B 26/18; C04B 40/0032; C04B 40/0067; C04B 40/0071; C04B 40/0082; C04B 2111/00017

(57) ABSTRACT

An environmentally-friendly quartz composite board and a manufacturing method therefor are provided. A raw material of the environmentally-friendly quartz composite board includes a quartz particle, a building material waste particle, a resin, a coupling agent and a curing agent. After the raw materials are stirred, mixed, pressed and cured, the required environmentally-friendly quartz composite board is obtained. The invention allows construction material waste that is originally difficult to use to be effectively recycled and reused, and provides an innovative and environmentally-friendly sustainable product, thereby meeting consumers' expectations for the industry on ESG issues.

### BACKGROUND OF THE INVENTION

This application claims priority for the TW patent application no. 11149273 filed on 21 Dec. 2023, the content of which is incorporated by reference in its entirely.

### FIELD OF THE INVENTION

The invention relates to the technical field of quartz composite board, in particular, to an environmentally-friendly quartz composite board and a manufacturing method therefor.

### DESCRIPTION OF THE PRIOR ART

As environmental awareness gradually rises, consumers begin to use environmentally-friendly products to implement their personal environmentally-friendly actions, and enterprises need to pay attention to the sustainable circular economy and strive to manage ESG-environmental protection, i.e., Environment, Social, and Governance indicators, while the manufacturing industry must also undergo transformation, so as to have the opportunity to achieve a low-carbon operating model, thereby not only achieving the goal of “carbon neutrality”, but also achieving environmental protection within the scope of ESG. ESG environmental protection projects include elements of circular economy. The basic spiritual concept of circular economy is 3R, which is Reduce, Reuse and Recycle, so that all resources can be reused, reducing the use of original materials and reducing waste generation.

On the other hand, the quartz composite board is a polymer stone material made from a mixture of a natural quartz, a resin and a pigment, and is pressed by a special machine under certain physical and chemical conditions. The quartz composite board is an environmentally-friendly and green new building material that has no radioactive pollution and can be reused. It is regarded as the new favorite of the stone material market and is widely used in various areas of life, such as in bathrooms, cabinets, laboratory countertops, floors and walls of hospitals and large shopping malls, etc.

In order to promote the sustainable recycling of resources, the applicant has painstakingly researched, thought and designed an environmentally-friendly quartz composite board and a manufacturing method therefor for many years, so as to focus on how to combine the concepts of the quartz composite board and the waste circular economy, thereby promoting the implementation and utilization of ESG issues in the industry.

### SUMMARY OF THE INVENTION

A main objective of the invention is to provide an environmentally-friendly quartz composite board and a manufacturing method therefor to mix the building material waste in the raw materials of the environmentally-friendly quartz composite board for allowing construction material waste that is originally difficult to use to be effectively recycled and reused, thereby meeting consumers' expectations for the industry on ESG issues.

To achieve the above objective, the invention provides an environmentally-friendly quartz composite board, which includes raw materials of:
(a) a quartz particle of 64˜84% by weight;
(b) a building material waste particle of 10˜30% by weight;
(c) a resin of 5.65˜9.6% by weight;
(d) a coupling agent of 0.004˜0.006% by weight; and
(e) a curing agent of 0.04˜0.06% by weight.

In an embodiment of the invention, the quartz particle includes: a quartz sand of 30˜35% by weight with an average particle size of 0.1˜0.2 mm, a quartz sand of 20˜30% by weight with an average particle size of 0.2˜0.4 mm, and a quartz powder of 20˜30% by weight with an average particle size of 45 μm.

In an embodiment of the invention, the building material waste particle is selected from one or more of a cement, a glass, a marble, a granite and a tile.

In an embodiment of the invention, an average particle size of the building material waste particle is 0.1˜0.5 mm.

In an embodiment of the invention, the resin includes an unsaturated polyester resin, the coupling agent includes a silane coupling agent, and the curing agent includes an organic peroxide.

In an embodiment of the invention, the environmentally-friendly quartz composite board further includes a colorant of trace amount.

In addition, the invention further provides a manufacturing method for the environmentally-friendly quartz composite board, which includes steps of:
(1) weighing each ingredient separately according to a formula: the quartz particle of 64˜84% by weight, a building material waste particle of 10˜30% by weight, a resin of 5.65˜9.6% by weight, a coupling agent of 0.004˜0.006% by weight, and a curing agent of 0.04˜0.06 by weight;
(2) stirring and mixing: stirring the resin in a high-speed mixer, then adding the coupling agent for stirring together for about 1 minute, and then adding the curing agent for stirring together for about 2 minutes, followed by adding the quartz particle and the building material waste particle for stirring together for about 9 minutes, so as to form a mixture;
(3) pressing: transporting the mixture to a high-frequency vibrating vacuum press to be pressed into an initial board; and
(4) curing: placing the initial board in a curing device to be cured at 50° C., so as to form the environmentally-friendly quartz composite board.

In an embodiment of the invention, subsequent steps of the step (4) include steps of:
(5) polishing: wet-cutting and polishing the cured environmentally-friendly quartz composite board in a polishing device.

In an embodiment of the invention, the quartz particle includes: a quartz sand of 30˜35% by weight with an average particle size of 0.1˜0.2 mm, a quartz sand of 20˜30% by weight with an average particle size of 0.2˜0.4 mm, and a quartz powder of 20˜30% by weight with an average particle size of 45 μm; and wherein in the step (2), when the quartz particle is added, first the quartz sand with an average particle size of 0.1˜0.2 mm and the quartz sand with an average particle size of 0.2˜0.4 mm are added for stirring for 4 minutes, and then the quartz powder is added for stirring for 5 minutes.

In an embodiment of the invention, the building material waste particle is selected from one or more of a cement, a glass, a marble, a granite and a tile.

In an embodiment of the invention, an average particle size of the building material waste particle is 0.1˜0.5 mm.

In an embodiment of the invention, the resin includes an unsaturated polyester resin, the coupling agent includes a silane coupling agent, and the curing agent includes an organic peroxide.

In an embodiment of the invention, in the step (2), after the resin is stirred, a step of adding the colorant of trace amount for stirring together for 3˜6 minutes.

According to the environmentally-friendly quartz composite board and the manufacturing method therefor provided by the invention, the usage characteristics of the building material waste may be effectively utilized, the efficiency in using resources may be improved, and the waste generation is reduced while reducing the carbon emissions, thereby providing innovative and environmentally-friendly sustainable products to achieve the goal of “carbon neutrality” and achieving ESG at the same time. At the same time, the structural composition and production method of the invention are quite simple and safe, and may be effectively promoted to the public as an ideal environmentally-friendly building material, helping to achieve the goal of circular economy.

The above description can only be used to describe the problems to be solved by the invention, the technical means to solve the problems and their effects, etc. The specific details of the invention will be introduced in detail in the following embodiments and related drawings.

### BRIEF DESCRIPTION OF THE DRAWINGS

FIG. 1 is a structural diagram of the composition of an environmentally-friendly quartz composite board provided by the invention.

FIG. 2 is a flowchart of a manufacturing method for the environmentally-friendly quartz composite board provided by the invention.

### DESCRIPTION OF THE PREFERRED EMBODIMENTS

In order to clearly disclose the technical features of an environmentally-friendly quartz composite board and a manufacturing method therefor disclosed in the invention, specific embodiments will be presented below to illustrate the technical features of the invention in detail, and at the same time, drawings will be used to demonstrate these technical features.

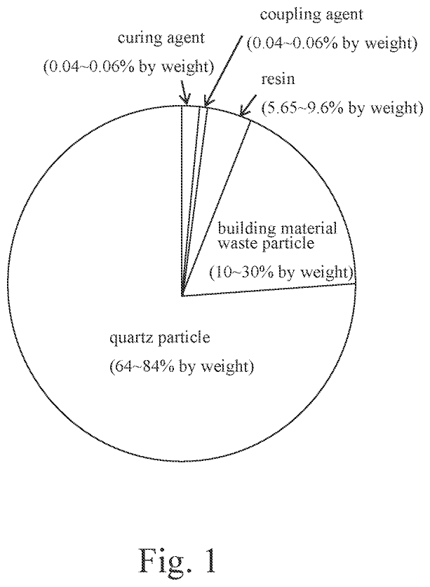

With reference to FIG. 1, a structural diagram of the composition of an environmentally-friendly quartz composite board provided by the invention is shown. According to the environmentally-friendly quartz composite board provided by the invention, which mainly uses a quartz particle, a building material waste particle, a resin, a coupling agent, and a curing agent as raw materials. Based on the total weight of raw materials, a content of quartz particle is 64˜84% by weight, a content of the building material waste particle is 10˜30% by weight, a content of the resin is 5.65˜9.6% by weight, a content of the coupling agent is 0.004˜0.006% by weight, and a content of the curing agent is 0.04˜0.06% by weight. The proportion of the area occupied by each component in the figures does not represent the actual composition ratio.

Further, the quartz particle selected in the invention is preferably a quartz particle of different particle sizes, including a quartz sand with an average size of 0.1˜0.2 mm, a quartz sand with an average size of 0.2˜0.4 mm, and a quartz powder with an average size of 45 μm; their weight percentages in quartz particles are: the quartz sand with an average particle size of 0.1˜0.2 mm accounts for 30˜35% by weight, the quartz sand with an average particle size of 0.2˜0.4 mm accounts for 40˜45% by weight, and the quartz powder with an average particle size of 45 μm accounts for 20˜30% by weight.

The building material waste particle selected in the invention may be one or more of a cement, a glass, a marble, a granite and a tile. An average particle size of the building material waste particle is preferably 0.1˜0.5 mm, but in practice is not limited to this.

The resin selected in the invention is preferably an unsaturated polyester resin (UP), but in practice is not limited thereto.

The coupling agent selected in the invention is preferably a silane coupling agent, so that a molecular bond between the resin and the quartz may be bonded more closely and firmly. For example, the silane coupling agent includes γ-methacryloxypropyltrimethoxysilane, γ-(2,3-glycidoxy)propyltrimethoxysilane, N-β(aminoethyl)-γ-aminopropylmethyldimethoxysilane, N-(β-aminoethyl)-γ-aminopropyltriethoxysilane, N-β(aminoethyl)γ-aminopropyltrimethoxysilane, anilinemethyltriethoxysilane, γ-aminopropyltriethoxysilane, vinyltriethoxysilane, vinyltrimethoxysilane, or γ-chloropropyltriethoxysilane.

The curing agent selected in the invention is preferably an organic peroxide, but is not limited thereto. For example, the curing agent includes (2-ethylhexanoate) tert-butyl peroxide, butanone peroxide, tert-butyl peroxide or dibenzoyl peroxide.

A colorant of trace amount may further be added to the composition of the raw materials of the environmentally-friendly quartz composite board of the invention.

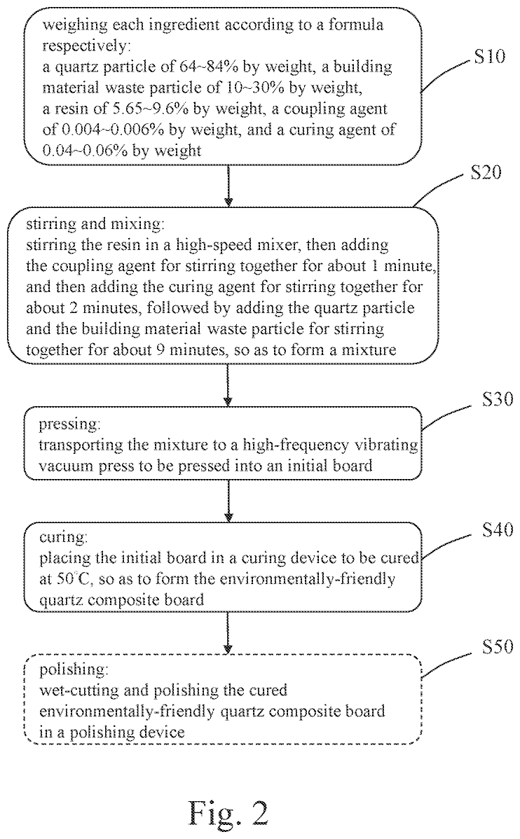

Next, with reference to FIG. 2, a flowchart of a manufacturing method for the environmentally-friendly quartz composite board provided by the invention is shown. Five steps S10-S50 are shown in the figure. Steps S10-S40 describe the manufacturing method for the environmentally-friendly quartz composite board. In step S50, it is defined that one possible step may be selected to be added in the preparation process of the environmentally-friendly quartz composite board. For the sake of simplicity, these steps are presented together (dotted boxes indicate that the method feature is optional) in a single flowchart. The manufacturing method of the invention includes the following steps:

First, as shown in step S10, each ingredient are weighed separately according to a formula (as shown in the composition of FIG. 1): the quartz particle of 64˜84% by weight, a building material waste particle of 10˜30% by weight, a resin of 5.65˜9.6% by weight, a coupling agent of 0.004˜0.006% by weight, and a curing agent of 0.04˜0.06 by weight.

Next, as shown in step S20, i.e., stirring and mixing: according to the amount weighed in step S10, the resin is introduced into a high-speed mixer for stirring uniformly, then the coupling agent is added for stirring together for about 1 minute, and then the curing agent is added for stirring together for about 2 minutes, followed by adding the quartz particle and the building material waste particle for stirring together for about 9 minutes, so as to form a mixture.

Next, as shown in step S30, i.e., pressing: the mixture is transported to a high-frequency vibrating vacuum press to be pressed into an initial board.

Subsequently, as shown in step S40, i.e., curing: the initial board is placed in a curing device to be cured at 50° C., so as to form the environmentally-friendly quartz composite board of the invention.

In an optional preparation method, as shown in step S50, the manufacturing method of the invention, after step S40, further includes a subsequent step of polishing: the cured environmentally-friendly quartz composite board is wet-cut and polished in a polishing device so as to be shipped as a product.

Further, the quartz particle selected in the manufacturing method of the invention includes a quartz sand with an average size of 0.1˜0.2 mm, a quartz sand with an average size of 0.2˜0.4 mm, and a quartz powder with an average size of 45 μm; their weight percentages in quartz particles are: the quartz sand with an average particle size of 0.1˜0.2 mm accounts for 30˜35% by weight, the quartz sand with an average particle size of 0.2˜0.4 mm accounts for 40˜45% by weight, and the quartz powder with an average particle size of 45 μm accounts for 20˜30% by weight. In the manufacturing method of the invention, in step S20, when the quartz particle is added, first the quartz sand with an average particle size of 0.1˜0.2 mm and the quartz sand with an average particle size of 0.2˜0.4 mm are added for stirring for 4 minutes, and then the quartz powder is added for stirring for 5 minutes, so as to form a mixture for the subsequent pressing and curing.

In order to adapt to the colors required by different users, in the manufacturing method of the invention, further in step S20, after the resin is stirred, the method further includes adding a colorant of trace amount for stirring together for 3˜6 minutes.

The following examples illustrate embodiments of the invention:

The environmentally-friendly quartz composite board of the embodiment of the invention has raw materials prepared by a quartz particle of 64% by weight, a building material waste particle of 30% by weight, a resin of 5.85% by weight, a coupling agent of 0.006% by weight, a curing agent of 0.04% by weight, and a colorant of trace amount. The manufacturing method is: after each ingredient is weighed according to the above formula, first the resin is stirred uniformly in a high-speed mixer, then the coupling agent is added for stirring together for about 1 minute, and then the curing agent is added for stirring together for about 2 minutes, and finally the quartz particle and the building material waste particle are stirred together for about 9 minutes, wherein the quartz particle includes a quartz sand of 30˜35% by weight with an average particle size of 0.1˜0.2 mm, a quartz sand of 45% by weight with an average particle size of 0.2˜0.4 mm, and a quartz powder of 20% by weight, the building material waste particle having an average particle size of 0.1˜0.5 mm, which are added in a sequence of first adding the above two quartz sands for stirring for 4 minutes, then adding the quartz powder for stirring for 5 minutes, and then adding the building material waste particle for stirring for 5 minutes, so as to form a mixture. Then, the mixture is transported to a high-frequency vibrating vacuum press to be pressed into an initial board. And them, the initial board is placed in a curing device to be cured at 50° C., so as to form the environmentally-friendly quartz composite board. Finally, the cured environmentally-friendly quartz composite board is wet-cut and polished in a polishing device so as to complete the product with a polished surface.

In summary, according to the environmentally-friendly quartz composite board and the manufacturing method therefor, by successfully adding the building material waste that is difficult to recycle into the raw materials of the environmentally-friendly quartz composite board produced, an innovative and environmentally sustainable product may be provided, which not only may reduce the equivalent of carbon dioxide emissions and may also meet the environmental protection requirements of 3R (reduce, recycle, reuse), but also may achieve the effect of energy saving, thereby helping enhance the implementation and utilization of the industry in ESG issues. Moreover, the structural composition and production method of the environmentally-friendly quartz composite board provided by the invention are quite simple and safe, and may be widely promoted to the public as an ideal environmentally-friendly building material, helping to achieve the goal of circular economy.

The above mentioned is only the preferred embodiments of the present invention and is not intended to limit the scope of the implementation of the present invention. Therefore, any equivalent changes or modifications made according to the features and spirit described within the scope of the present invention should be included within the claims of the present invention.

What is claimed is:

1. An environmentally-friendly quartz composite board, comprising raw materials of:
(a) a quartz particle of 64˜84% by weight;
(b) a building material waste particle of 10˜30% by weight;
(c) a resin of 5.65˜9.6% by weight;
(d) a coupling agent of 0.004˜0.006% by weight; and
(e) a curing agent of 0.04˜0.06% by weight.

2. The environmentally-friendly quartz composite board according to claim 1, wherein the quartz particle comprises:
a quartz sand of 30˜35% by weight with an average particle size of 0.1˜0.2 mm, a quartz sand of 20˜30% by weight with an average particle size of 0.2˜0.4 mm, and a quartz powder of 20˜30% by weight with an average particle size of 45 μm.

3. The environmentally-friendly quartz composite board according to claim 1, wherein the building material waste particle is a cement, a glass, a marble, a granite, a tile or a combination thereof.

4. The environmentally-friendly quartz composite board according to claim 1, wherein an average particle size of the building material waste particle is 0.1˜0.5 mm.

5. The environmentally-friendly quartz composite board according to claim 1, wherein the resin comprises an unsaturated polyester resin, the coupling agent comprises a silane coupling agent, and the curing agent comprises an organic peroxide.

6. The environmentally-friendly quartz composite board according to claim 1, further comprising a colorant.

7. A manufacturing method for the environmentally-friendly quartz composite board, comprising steps of:
(1) weighing each ingredient separately according to a formula: the quartz particle of 64˜84% by weight, a building material waste particle of 10˜30% by weight, a resin of 5.65˜9.6% by weight, a coupling agent of 0.004˜0.006% by weight, and a curing agent of 0.04˜0.06 by weight;
(2) stirring and mixing: stirring the resin in a high-speed mixer, then adding the coupling agent for stirring together for about 1 minute, and then adding the curing agent for stirring together for about 2 minutes, followed by adding the quartz particle and the building material waste particle for stirring together for about 9 minutes, so as to form a mixture;
(3) pressing: transporting the mixture to a high-frequency vibrating vacuum press to be pressed into an initial board; and
(4) curing: placing the initial board in a curing device to be cured at 50° C., so as to form the environmentally-friendly quartz composite board.

8. The manufacturing method for the environmentally-friendly quartz composite board according to claim 7, wherein subsequent steps of the step (4) comprise steps of:
(5) polishing: wet-cutting and polishing the cured environmentally-friendly quartz composite board in a polishing device.

9. The manufacturing method for the environmentally-friendly quartz composite board according to claim 7, wherein the quartz particle comprises:
a quartz sand of 30˜35% by weight with an average particle size of 0.1˜0.2 mm, a quartz sand of 20˜30% by weight with an average particle size of 0.2˜0.4 mm, and a quartz powder of 20˜30% by weight with an average particle size of 45 μm;
and wherein in the step (2), when the quartz particle is added, first the quartz sand with an average particle size of 0.1˜0.2 mm and the quartz sand with an average particle size of 0.2˜0.4 mm are added for stirring for 4 minutes, and then the quartz powder is added for stirring for 5 minutes.

10. The manufacturing method for the environmentally-friendly quartz composite board according to claim 7, wherein the building material waste particle is a cement, a glass, a marble, a granite, a tile or a combination thereof.

11. The manufacturing method for the environmentally-friendly quartz composite board according to claim 7, wherein an average particle size of the building material waste particle is 0.1˜0.5 mm.

12. The manufacturing method for the environmentally-friendly quartz composite board according to claim 7, wherein the resin comprises an unsaturated polyester resin, the coupling agent comprises a silane coupling agent, and the curing agent comprises an organic peroxide.

13. The manufacturing method for the environmentally-friendly quartz composite board according to claim 7, wherein in the step (2), after the resin is stirred, a step of adding the colorant for stirring together for 3˜6 minutes.
